(19) United States
(12) Patent Application Publication
(10) Pub. No.: US 2011/0292908 A1
(43) Pub. Date: Dec. 1, 2011

(54) Additional Service Type Setup in Mobile Terminals Having Multiple Radio Access Network Accessiblity

(76) Inventors: Tom Chin, San Diego, CA (US); Guangming Shi, San Diego, CA (US); Kuo-Chun Lee, San Diego, CA (US)

(21) Appl. No.: 12/883,955

(22) Filed: Sep. 16, 2010

Related U.S. Application Data
(60) Provisional application No. 61/348,368, filed on May 26, 2010.

(51) Int. Cl. H04W 60/00; H04W 36/00; H04W 88/06; H04W 76/02

(52) U.S. Cl. 370/331; 370/328

(57) ABSTRACT

In an area covered by multiple different radio access networks, a user equipment (UE) capable of accessing each of the multiple networks at the same time may provide additional service type setup for different call types. The UE registers each of the available call types with a first radio access network. Calls of one of the registered call types may be established, whether UE-originated or UE-terminated, with the first radio access network. When initiating a call of another type, the UE may initiate a different-typed call with another radio access network in the area, while maintaining the call of the first call type with the first radio access network.

### CROSS REFERENCE TO RELATED APPLICATION

This application claims the benefit of U.S. provisional patent application No. 61/348,368 filed May 26, 2010, in the names of CHIN et al., the disclosure of which is expressly incorporated herein by reference in its entirety.

### BACKGROUND

1. Field

Aspects of the present disclosure relate generally to wireless communication systems, and more particularly, to additional service type setup in mobile terminals that have the capability of multiple radio access network accessibility.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for wireless communication includes registering, with a UE, a first call type and a second call type with a first radio access network, establishing a call of the first call type with the first radio access network, and initiating a call of the second call type with a second radio access network while maintaining the call of the first call type with the first radio access network.

In another aspect of the disclosure, a method for wireless communication includes registering, with a UE, a first call type and a second call type with a first radio access network, establishing a call of the first call type and a call of the second call type with the first radio access network, and handing over the call of the second call type to a second radio access network while maintaining the call of the first call type with the first radio access network.

In a further aspect of the disclosure, a UE configured for wireless communication includes means for registering a first call type and a second call type with a first radio access network, means for establishing a call of the first call type with the first radio access network, and means for initiating a call of the second call type with a second radio access network while maintaining the call of the first call type with the first radio access network.

In a further aspect of the disclosure, a UE configured for wireless communication includes means for registering a first call type and a second call type with a first radio access network, means for establishing a call of the first call type and a call of the second call type with the first radio access network, and means for handing over the call of the second call type to a second radio access network while maintaining the call of the first call type with the first radio access network.

In an aspect of the disclosure, a computer program product includes a computer-readable medium having program code recorded thereon. The program code includes code to register a UE for a first call type and a second call type with a first radio access network, code to establish a call of the first call type with the first radio access network, and code to initiate a call of the second call type with a second radio access network while maintaining the call of the first call type with the first radio access network.

In another aspect of the disclosure, a computer program product includes a computer-readable medium having program code recorded thereon. The program code includes code to register a UE for a first call type and a second call type with a first radio access network, code to establish a call of the first call type and a call of the second call type with the first radio access network, and code to hand over the call of the second call type to a second radio access network while maintaining the call of the first call type with the first radio access network.

In a further aspect of the disclosure, a UE configured for wireless communication includes at least one processor and a memory coupled to the at least one processor. The processor is configured to register a first call type and a second call type with a first radio access network, to establish a call of the first call type with the first radio access network, and to initiate a call of the second call type with a second radio access network while maintaining the call of the first call type with the first radio access network.

In a further aspect of the disclosure, a UE configured for wireless communication includes at least one processor and a memory coupled to the at least one processor. The processor is configured to register a first call type and a second call type with a first radio access network, to establish a call of the first call type and a call of the second call type with the first radio access network, and to hand over the call of the second call type to a second radio access network while maintaining the call of the first call type with the first radio access network.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a diagram illustrating an overlaid network, in which a TD-SCDMA network is overlaid on a GSM network.

FIG. 5 is a block diagram of a UE configured to operate in a multiple radio access network location, such as the overlaid network from FIG. 4.

FIG. 6A is a functional block diagram illustrating example blocks executed to implement one aspect of the present disclosure.

FIG. 6B is a functional block diagram illustrating example blocks executed to implement another aspect of the present disclosure.

FIG. 7 is a call flow diagram illustrating a call flow configured according to one aspect of the present disclosure occurring between a UE, a TD-SCDMA network and a GSM network.

FIG. 8 is a call flow diagram illustrating a call flow occurring with a UE configured according to one aspect of the present disclosure.

FIG. 9 is a call flow diagram illustrating a call flow occurring with a UE configured according to one aspect of the present disclosure.

FIG. 10 is a call flow diagram illustrating a call flow occurring with a UE configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

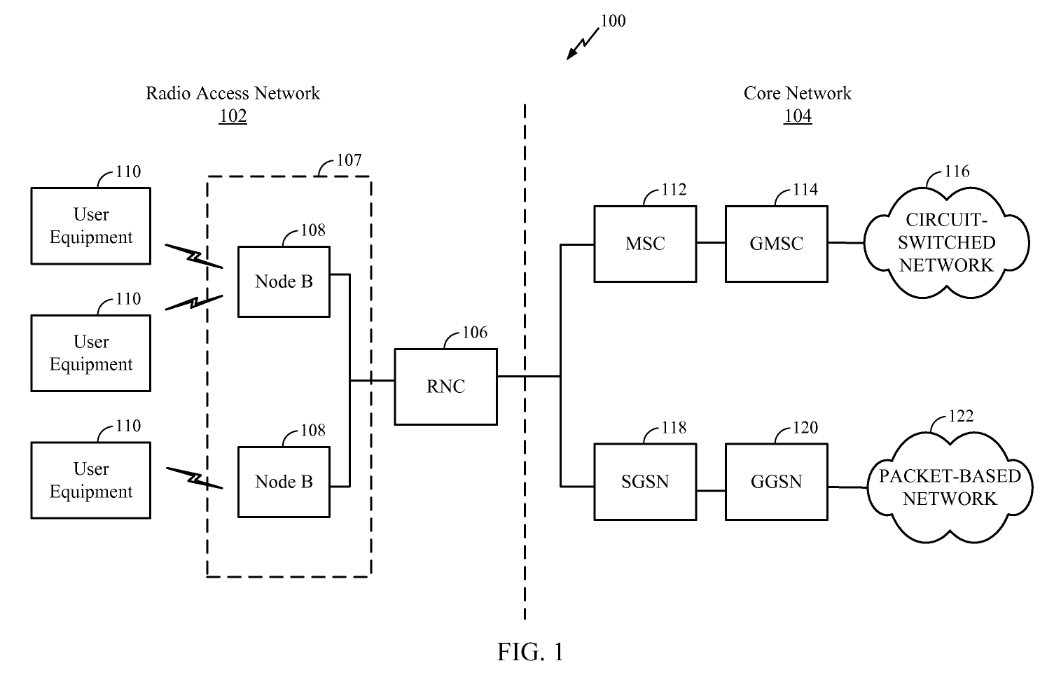

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

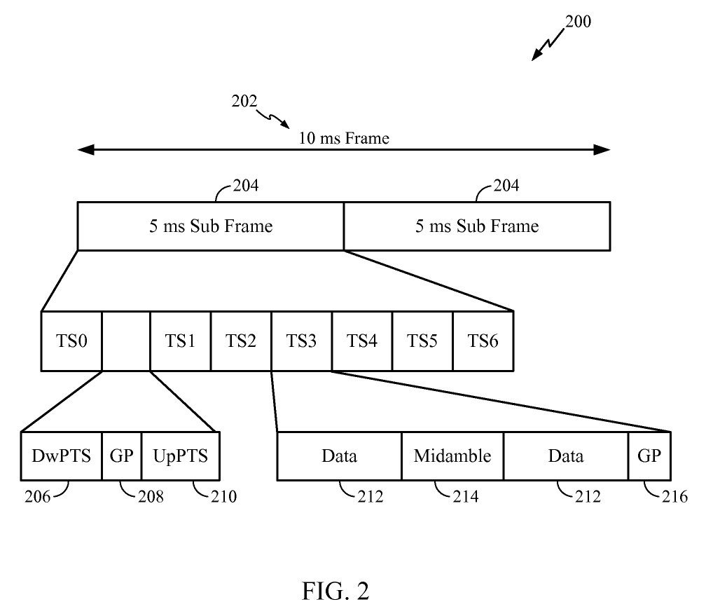

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

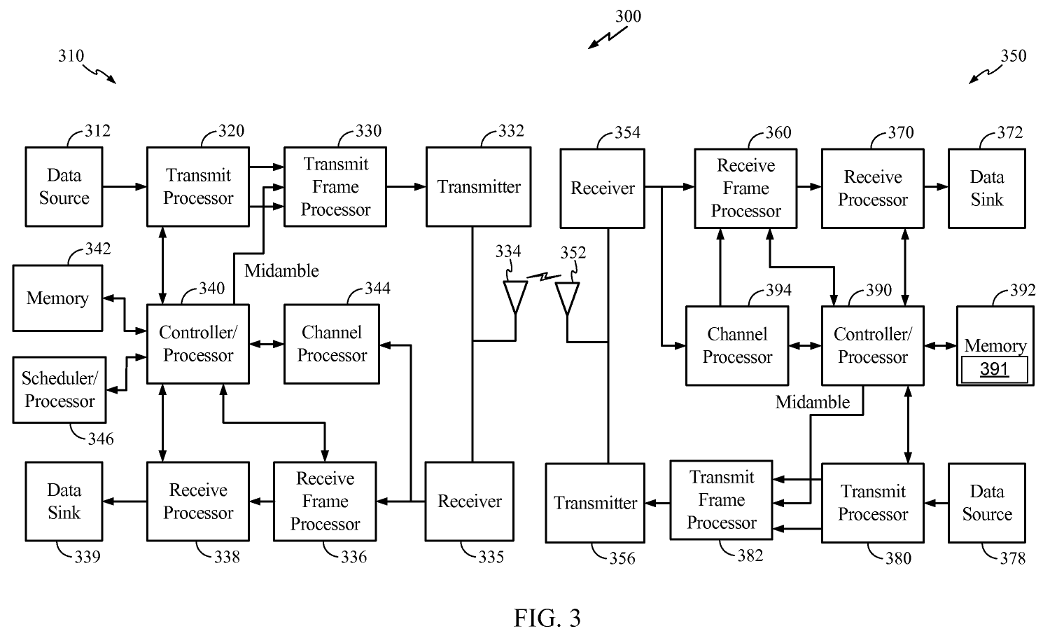

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a channel monitor module 391 which, when executed by the controller/processor 390, configures the UE 350 to adjust its control channel monitoring based on a physical layer indication received from a node B. A scheduler/processor 346 at the node B 310 may be used to allocate resources to the UEs and schedule downlink and/or uplink transmissions for the UEs.

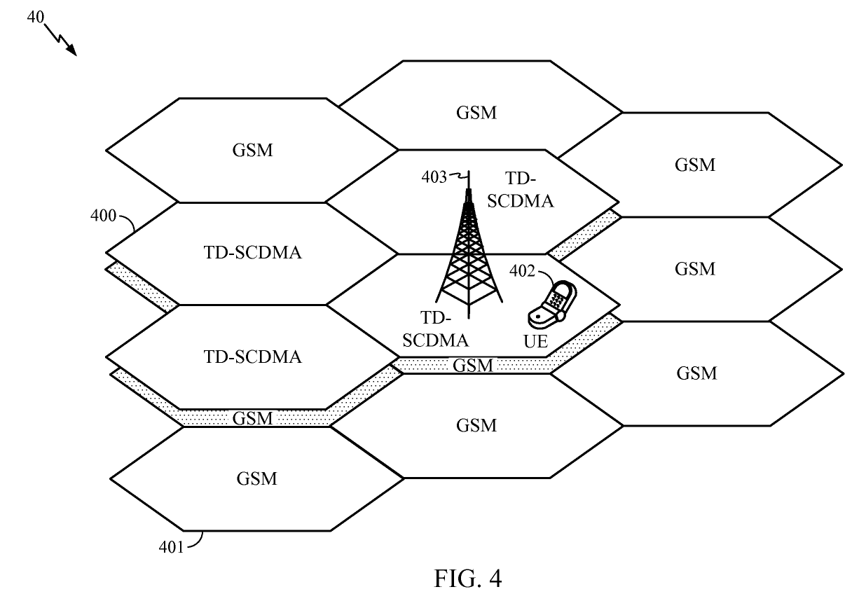

FIG. 4 is a diagram illustrating an overlaid network 40, in which a TD-SCDMA network 400 is overlaid on a GSM network 401. As TD-SCDMA networks, such as TD-SCDMA network 400, have not been deployed to the level of GSM networks, such as GSM network 401, the overlaid network 40 may be a configuration in areas where TD-SCDMA networks are deployed. A UE 402 is configured to maintain communication with both the TD-SCDMA network 400 and the GSM network 401. A base station 403 may provide access to both the TD-SCDMA network 400 and the GSM network 401. In many cases, there will be handovers between the TD-SCDMA network 400 and the GSM network 401 with the UE 402 depending on the location of the UE 402 and the signal strength exhibited by the networks.

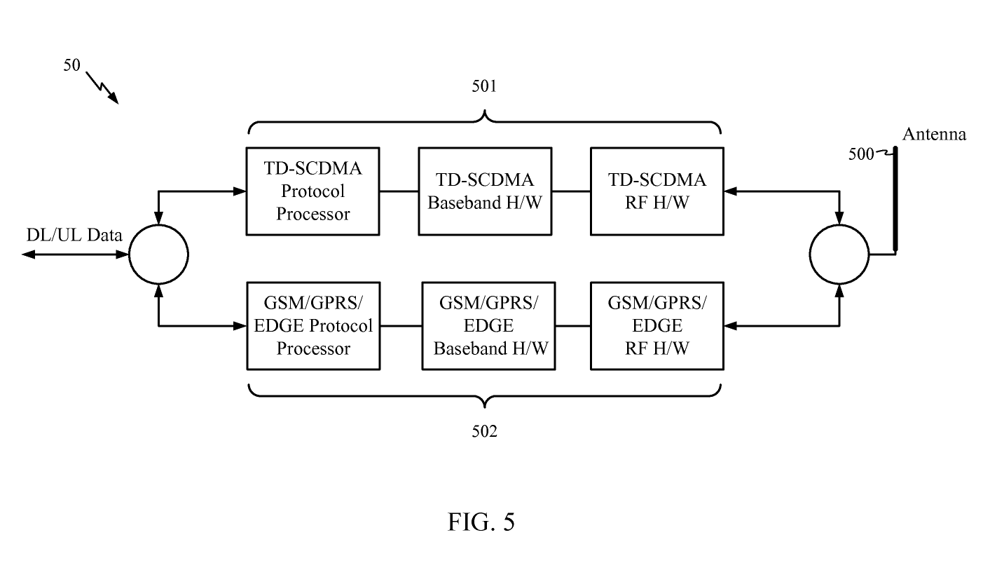

FIG. 5 is a block diagram of a UE 50 configured to operate in a multiple radio access network location, such as the overlaid network 40. The UE 50 includes an antenna 500 for receiving and transmitting signals onto the networks. There are also two separate processing paths, the TD-SCDMA processing section 501 and the GSM processing section 502. The TD-SCDMA processing section 501 includes a TD-SCDMA protocol processor, TD-SCDMA baseband hardware, and TD-SCDMA RF hardware. THE GSM processing section 502 includes a GSM/GPRS/EDGE protocol processor, GSM/GPRS/EDGE baseband hardware, and GSM/GPRS/EDGE RF hardware.

When communication with the UE 50 occurs over a TD-SCDMA network, such as the TD-SCDMA network 400, all of the signals and messages received through the antenna 500 will be processed in the TD-SCDMA hardware of the TD-SCDMA processing section 501. Similarly, when communication with the UE 50 occurs over a GSM network, such as the GSM network 401, all of the signals and messages received through the antenna 500 are processed by the GSM hardware of the GSM processing section 502. Therefore, the UE 50 may simultaneously or concurrently process and maintain communication through either or both TD-SCDMA and GSM networks, such as the TD-SCDMA network 400 and the GSM network 401.

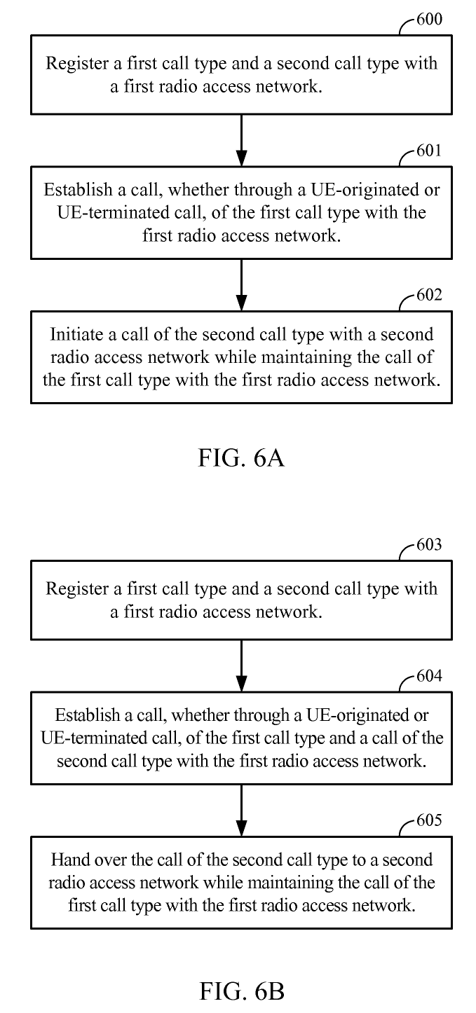

With UEs configured, such as the UE 50, to maintain communication with multiple different radio access networks, capabilities of obtaining additional service types from the different radio access networks become available. FIG. 6A is a functional block diagram illustrating example blocks executed to implement one aspect of the present disclosure. In block 600, a UE registers a first call type and a second call type with a first radio access network. A call, whether through a UE-originated or UE-terminated call, of said first call type is established, in block 601, with the first radio access network. The UE initiates a call of the second call type, in block 602, with a second radio access network while maintaining the call of the first call type with the first radio access network.

In another aspect of the present disclosure, a particular call type may have quality of service requirements that provide for immediate response to a particular call, such as when handling an incoming voice call. For such call types, a handover process may be defined. FIG. 6B is a functional block diagram illustrating example blocks executed to implement another aspect of the present disclosure. In block 603, a UE registers a first call type and a second call type with a first radio access network. A call, whether through a UE-originated or UE-terminated call, of the first call type and a call of the second call type are established, in block 604, with the first radio access network. The call of the second call type is handed over, in block 605, to a second radio access network while maintaining the call of the first call type with the first radio access network.

By providing for such additional service type setups, a UE that is capable of maintaining communication with multiple different radio access networks may set up different service types with different accessible radio access networks based on many different factors, such as which network may currently have the best signal qualities, which network, in general, handles the particular call types better, or the like. For example, in general, TD-SCDMA networks may handle packet-switched communications better than GSM networks, and GSM networks may handle circuit-switched communications better than TD-SCDMA networks. Thus, a UE handling both circuit-switched and packet-switched communications may select to maintain circuit-switched communications in a GSM network at the same time it maintains packet-switched communications in a TD-SCDMA network.

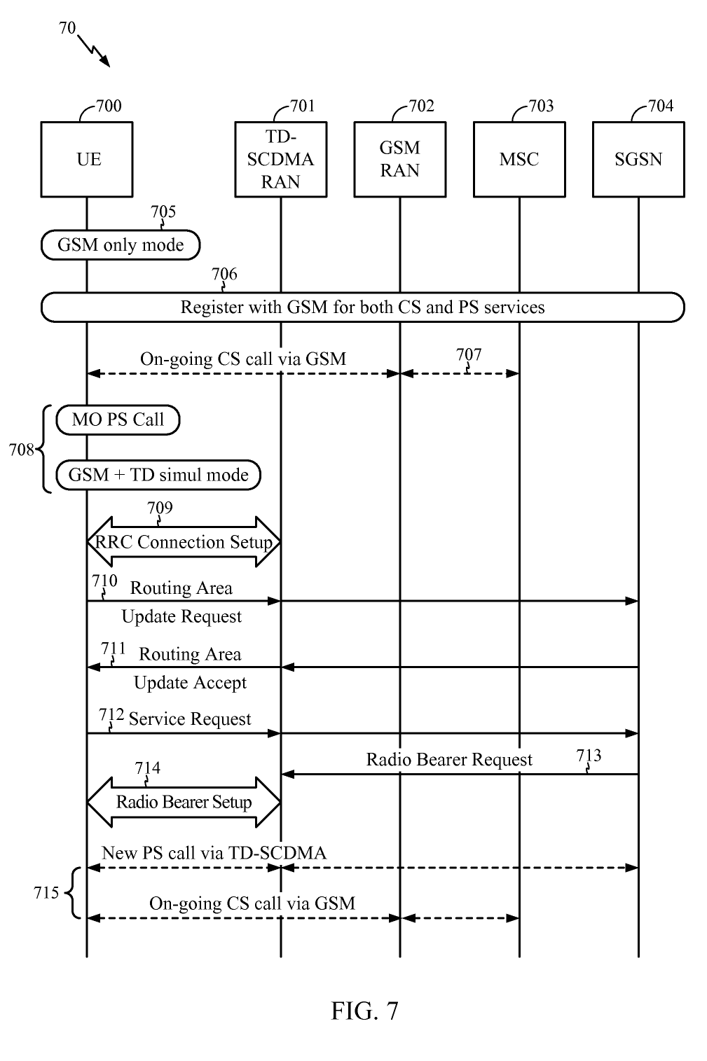

FIG. 7 is a call flow diagram illustrating a call flow 70 configured according to one aspect of the present disclosure occurring between a UE 700, a TD-SCDMA network 701 and a GSM network 702. At time 705, the UE 700 operates in a GSM-only mode. The UE 700 registers, at time 706, both packet-switched (PS) and circuit-switched (CS) service types with the GSM network 702. At time 707, the UE 700 maintains an on-going circuit-switched call with the GSM network 702 including communications with a mobile switching center (MSC) 703. The UE 700 begins to set up a packet-switched call at time 708, which prompts the UE 700 to enter a dual network simultaneous (simul) communication mode. The UE 700 sets up radio resources with the TD-SCDMA network 701 at time 709 using radio resource control (RRC) setup messages. At time 710, the UE 700 performs routing area update (RAU) requests to update location and transfer context to the TD-SCDMA network 701 and a serving GPRS support node (SGSN) 704, thus, registering packet-switched service types now with the TD-SCDMA network 701. The UE 700 receives the RAU acknowledgement from the SGSN 704 and TD-SCDMA network 701 at time 711, and transmits a new service setup request for a packet-switched call at time 712. The SGSN 704 returns a radio bearer request to the TD-SCDMA network 701 at time 713, after which the TD-SCDMA network 701 conducts radio bearer setup with the UE 700 at time 714. Once the radio bearer setup has been completed, the UE 700 places a new packet-switched call through the TD-SCDMA network 701 and the SGSN 704 at time 715, at the same time as the circuit-switched call is maintained via the GSM network 702 and the MSC 703.

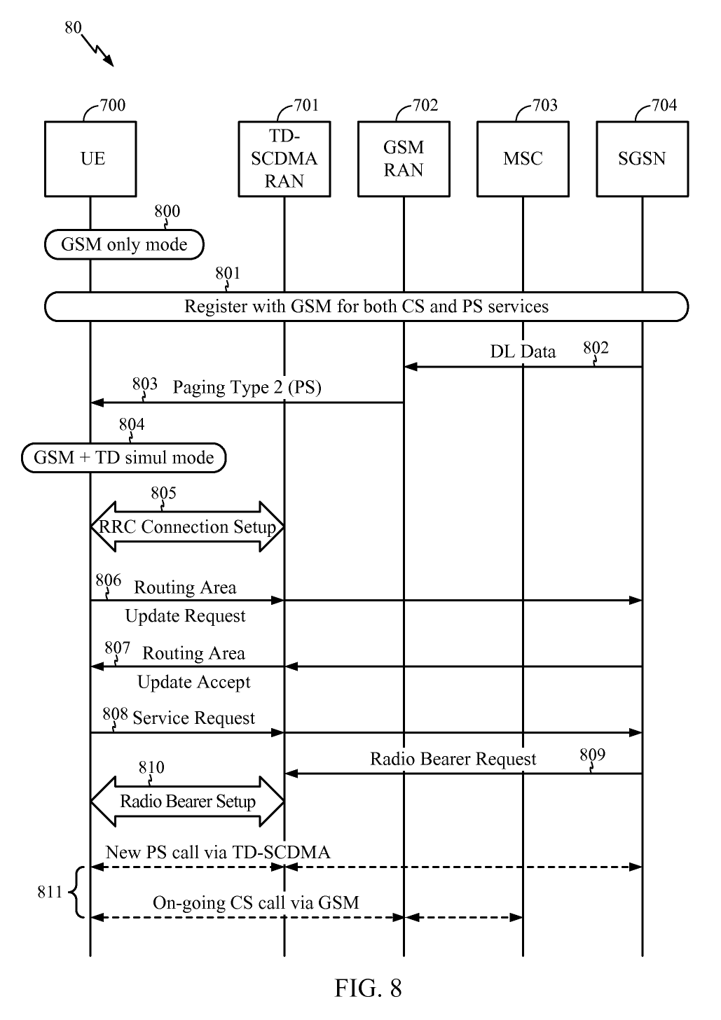

The various aspects of the present disclosure also apply to UE-terminated calls. FIG. 8 is a call flow diagram illustrating a call flow 80 occurring with a UE 700 configured according to one aspect of the present disclosure. At time 800, the UE 700 continues operation only in a GSM mode and is maintaining a circuit-switched call (not shown) using the GSM network 702 and the MSC 703. At time 801, the UE 700 registers circuit-switched and packet-switched call types with the GSM network 702. At time 802, the GSM network 702 receives downlink (DL) data indicating an incoming packet-switched call addressed to the UE 700.

The GSM network 702 then transmits a page to the UE 700 at time 803. The receipt of the page triggers the UE 700 to enter into a dual network communication mode at time 804, after which radio resources are reserved with the TD-SCCMA network 701 through RRC messages transmitted at time 805.

Registration of the packet-switched call type is updated using a RAU request transmitted from the UE 700 to the TD-SCDMA network 701 and the SGSN 704. The RAU acceptance/acknowledgement is received by the UE 700 at time 807, after which the service requests are transmitted from the UE 700 to the TD-SCDMA network 701 and the SGSN 704 at time 808. At time 809, the SGSN transmits the radio bearer request to the TD-SCDMA network 701, which then performs the radio bearer setup with the UE 700 at time 810. The incoming packet-switched call is then established with the UE 700, at time 811, at the same time that the on-going circuit-switched call is taking place with the GSM network 702 and the MSC 703. Therefore, when an incoming call of a type that is better served on the TD-SCDMA network 701 is received at the GSM network 702, the UE 700 can re-register that service type with the TD-SCDMA network 701 and establish the call over that network.

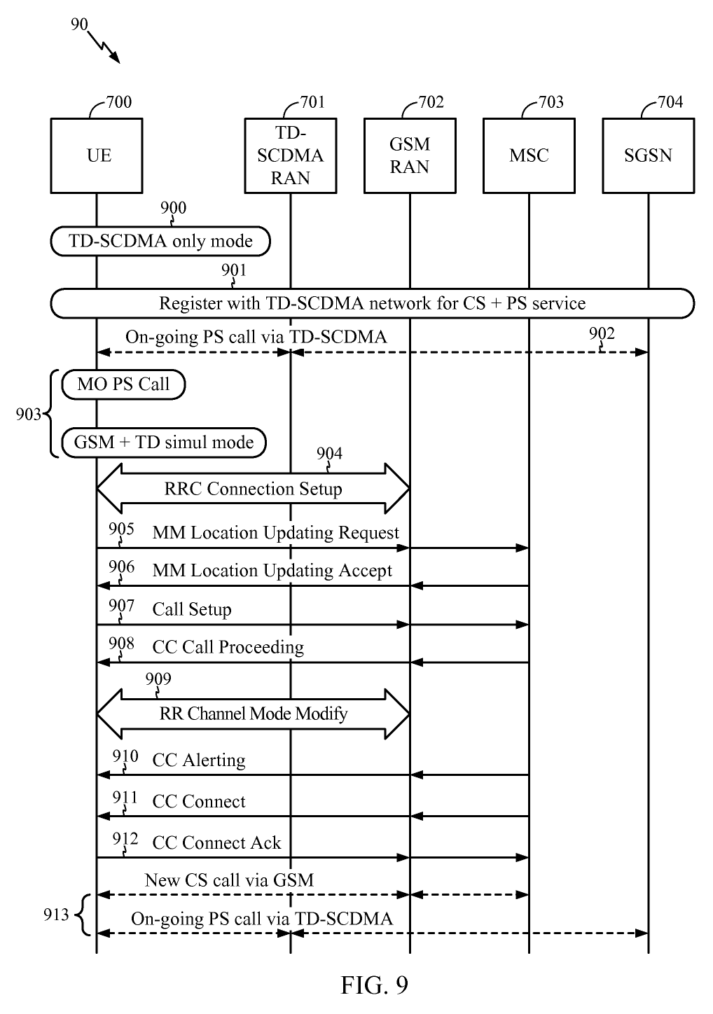

FIG. 9 is a call flow diagram illustrating a call flow 90 occurring with a UE 700 configured according to one aspect of the present disclosure. At time 900, the UE 700 is in a TD-SCDMA communication mode only. The UE 700 registers its call types, including packet-switched call types and circuit-switched call types with the TD-SCDMA network 701 at time 901. The UE 700 conducts a packet-switched call, at time 902, via the TD-SCDMA network 701 and the SGSN 704. At time 903, the UE 700 initiates a circuit-switched call, which triggers the UE 700 to switch to a dual network communication mode. At time 904, the UE 700 begins radio resource connections with the GSM network 702. The circuit-switched call types are then re-registered with the GSM network 702 using location area update (LAU) requests with the GSM network 702 and the MSC 703, at time 905. After receiving the LAU acceptance/acknowledgements from the MSC 703 and the GSM network 702, the UE 700 performs circuit-switched call setup beginning at times 907 and 908, with the circuit call setup and circuit call proceeding communications with the GSM network 702 and the MSC 703.

At time 909, the UE 700 and the GSM network 702 provide the channel mode modifications, after which the UE 700 receives the circuit call (CC) alerting and connection notifications, at times 910 and 911, respectively. The UE 700 will transmit a connection acknowledgement to the GSM network 702 and the MSC 703 at time 912. Thus, at time 913, a new circuit-switched call is being conducted by the UE 700 via the GSM network 702 and the MSC 703 at the same time the packet-switched call is being maintained via the TD-SCDMA network 701 and the SGSN 704.

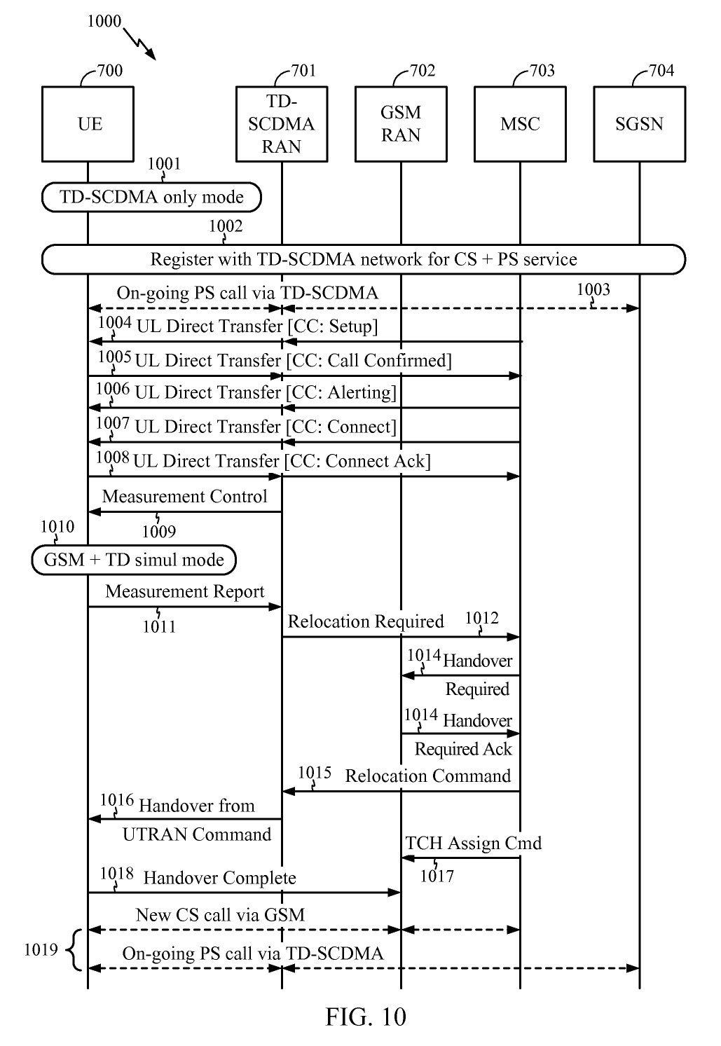

As noted, some call types may have special quality of service requirements that would require establishing the call in one of the radio access networks, but then handing over the call to another radio access network that the UE desired to make the call. FIG. 10 is a call flow diagram illustrating a call flow 1000 occurring with a UE 700 configured according to one aspect of the present disclosure. At time 1001, the UE 700 is in a TD-SCDMA communication mode only. The UE 700 registers its call types, including packet-switched call types and circuit-switched call types with the TD-SCDMA network 701 at time 1002. The UE 700 conducts a packet-switched call, at time 1003, via the TD-SCDMA network 701 and the SGSN 704. At time 1004, the MSC 703 and the TD-SCDMA network 701 receive and indication for an incoming circuit-switched voice call addressed to the UE 700. From time 1005 until time 1008, uplink (UL) and downlink communications between the UE 700 and the TD-SCDMA network 701 set up the circuit-switched call through the TD-SCDMA network 701. Because of the quality of service requirements of voice calls, the UE 700 may not wait to service the voice call until it can set up a dual network communication mode with the GSM network 702. The voice call would be completed and connected to the UE 700 using the TD-SCDMA network 701 at first.

At time 1009, after the circuit-switched voice call has been connected with the UE 700 using the TD-SCDMA network 701, the UE 700 receives a measurement control message which triggers it to enter into a dual network communication mode at time 1010. The UE 700 performs the signal measurements and transmits a measurement report to the TD-SCDMA network 701, at time 1011. The TD-SCDMA network 701 then transmits a relocation required message to the MSC 703 at time 1012. The MSC 703 signals a handover to the GSM network 702, at time 1013, after which the GSM network 702 acknowledges the handover request at time 1014. The MSC 703 then transmits a relocation command to the TD-SCDMA network 701 at time 1015, which then, at time 1016, signals the UE 700 to handover the circuit-switched voice call to the GSM network 702. The MSC 703 assigns a traffic channel (TCH) to the GSM network 702 for the handover at time 1017. Once the handover has been completed, the UE 700 transmits the handover complete message to the GSM network 702 at time 1018. At this point, time 1019, the circuit-switched voice call has been handed over and is on-going with the GSM network 702, at the same time the packet-switched call is being maintained via the TD-SCDMA network 701.

In one configuration, the apparatus, for example the UE 350, for wireless communication includes means for registering a first call type and a second call type with a first radio access network, means for establishing a call of the first call type with the first radio access network, and means for initiating a call of the second call type with a second radio access network while maintaining the call of the first call type with the first radio access network. In one aspect, the aforementioned means may be the antennas 352, the transmitter 356, the transmit frame processor 382, the transmit processor 380, the controller/processor 390, and the memory 392 configured to perform the functions recited by the aforementioned means. In another aspect, the aforementioned means may be a module or any apparatus configured to perform the functions recited by the aforementioned means.

In another configuration, the apparatus, for example the UE 350, for wireless communication includes means for registering a first call type and a second call type with a first radio access network, means for establishing a call of the first call type and a call of the second call type with the first radio access network, and means for handing over the call of the second call type to a second radio access network while maintaining the call of the first call type with the first radio access network. In one aspect, the aforementioned means may be the antennas 352, the transmitter 356, the transmit frame processor 382, the transmit processor 380, the controller/processor 390, and the memory 392 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system and a GSM system. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
registering a first call type and a second call type involving a first user equipment (UE) with a first radio access network;
establishing a call of said first call type with said first radio access network; and
initiating a call of said second call type with a second radio access network while maintaining said call of said first call type with said first radio access network.

2. The method of claim 1 further comprising:
updating registration of said second call type to said second radio access network.

3. The method of claim 1 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

4. The method of claim 1 wherein said call of said second call type originates at the first user equipment (UE) and said registering, said establishing, and said initiating occurring at said first UE.

5. The method of claim 1 wherein said call of said second call type originates at a second user equipment (UE) and said registering, said establishing, and said initiating occurring at the first UE receiving said call of said second type.

6. The method of claim 1 in which the first call type and second call type are one of:
the first call type is a packet-switched call and the second call type is a circuit-switched call; and
the second call type is a packet-switched call and the first call type is a circuit-switched call.

7. A method for wireless communication, comprising:
registering a first call type and a second call type involving a first user equipment (UE) with a first radio access network;
establishing a call of said first call type and a call of said second call type with said first radio access network; and
handing over said call of said second call type to a second radio access network while maintaining said call of said first call type with said first radio access network.

8. The method of claim 7 further comprising:
updating registration of said second call type to said second radio access network after said handing over said call of said second call type.

9. The method of claim 7 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

10. The method of claim 7 in which the first call type and second call type are one of:
the first call type is a packet-switched call and the second call type is a circuit-switched call; and
the second call type is a packet-switched call and the first call type is a circuit-switched call.

11. A user equipment (UE) configured for wireless communication, comprising:
means for registering a first call type and a second call type with a first radio access network;
means for establishing a call of said first call type with said first radio access network; and
means for initiating a call of said second call type with a second radio access network while maintaining said call of said first call type with said first radio access network.

12. The UE of claim 11 further comprising:
means for updating registration of said second call type to said second radio access network.

13. The UE of claim 11 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

14. The UE of claim 11 wherein said call of said second call type originates at another UE.

15. The UE of claim 11 in which the first call type and second call type are one of:
the first call type is a packet-switched call and the second call type is a circuit-switched call; and
the second call type is a packet-switched call and the first call type is a circuit-switched call.

16. A user equipment (UE) configured for wireless communication, comprising:
means for registering a first call type and a second call type with a first radio access network;
means for establishing a call of said first call type and a call of said second call type with said first radio access network; and
means for handing over said call of said second call type to a second radio access network while maintaining said call of said first call type with said first radio access network.

17. The UE of claim 16 further comprising:
means for updating registration of said second call type to said second radio access network after execution of said means for handing over said call of said second call type.

18. The UE of claim 16 wherein said first radio access network comprises a time division-synchronous code division multiple access (TD-SCDMA) network or a Global System Mobile (GSM) network; and
wherein said second radio access network comprises a global system mobile (GSM) network when the first radio access network comprises a TD-SCDMA network and comprises a TD-SCDMA network when the first radio access network comprises a GSM network.

19. The UE of claim 16 in which the first call type and second call type are one of:
the first call type is a packet-switched call and the second call type is a circuit-switched call; and
the second call type is a packet-switched call and the first call type is a circuit-switched call.

20. A computer program product, comprising:
a computer-readable medium having program code recorded thereon, said program code comprising:
program code to register a user equipment (UE) for a first call type and a second call type with a first radio access network;
program code to establish a call of said first call type with said first radio access network; and
program code to initiate a call of said second call type with a second radio access network while maintaining said call of said first call type with said first radio access network.

21. The computer program product of claim 20 further comprising:
program code to update registration of said second call type to said second radio access network.

22. The computer program product of claim 20 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

23. The computer program product of claim 20 wherein said call of said second call type originates at a first user equipment (UE) and said program code to register, said program code to establish, and said program code to initiate are executed at said first UE.

24. The computer program product of claim 20 wherein said call of said second call type originates at a second user equipment (UE) and said program code to register, said program code to establish, and said program code to initiate are executed at a first UE receiving said call of said second type.

25. The computer program product of claim 20 in which the first call type and second call type are one of:
the first call type is a packet-switched call and the second call type is a circuit-switched call; and
the second call type is a packet-switched call and the first call type is a circuit-switched call.

26. A computer program product, comprising:
a computer-readable medium having program code recorded thereon, said program code comprising:
program code to register a user equipment (UE) for a first call type and a second call type with a first radio access network;
program code to establish a call of said first call type and a call of said second call type with said first radio access network; and
program code to hand over said call of said second call type to a second radio access network while maintaining said call of said first call type with said first radio access network.

27. The computer program product of claim 26 further comprising:
program code to update registration of said second call type to said second radio access network after execution of said program code to hand over said call of said second call type.

28. The computer program product of claim 26 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

29. The computer program product of claim 26 in which the first call type and second call type are one of:
the first call type is a packet-switched call and the second call type is a circuit-switched call; and
the second call type is a packet-switched call and the first call type is a circuit-switched call.

30. A user equipment (UE) configured for wireless communication, comprising:
at least one processor; and
a memory coupled to the at least one processor,
wherein the at least one processor is configured:
to register a first call type and a second call type with a first radio access network;
to establish a call of said first call type with said first radio access network; and
to initiate a call of said second call type with a second radio access network while maintaining said call of said first call type with said first radio access network.

31. The UE of claim 30 wherein said at least one processor is further configured:
to update registration of said second call type to said second radio access network.

32. The UE of claim 30 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

33. The UE of claim 30 wherein said call of said second call type originates at said UE.

34. The UE of claim 30 wherein said call of said second call type originates at another UE.

35. The UE of claim 30 in which the first call type and second call type are one of:
the first call type is a packet-switched call and the second call type is a circuit-switched call; and
the second call type is a packet-switched call and the first call type is a circuit-switched call.

36. The UE of claim 30 in which the first call type and second call type are one of:
the first call type is a packet-switched call and the second call type is a circuit-switched call; and
the second call type is a packet-switched call and the first call type is a circuit-switched call.

37. A user equipment (UE) configured for wireless communication, comprising:
at least one processor; and
a memory coupled to the at least one processor,
wherein the at least one processor is configured:
to register a first call type and a second call type with a first radio access network;
to establish a call of said first call type and a call of said second call type with said first radio access network; and
to hand over said call of said second call type to a second radio access network while maintaining said call of said first call type with said first radio access network.

38. The UE of claim 37 wherein the at least one processor is further configured:
to update registration of said second call type to said second radio access network after said handing over said call of said second call type.

39. The UE of claim 37 wherein said first radio access network comprises a time division-synchronous code division multiple access (TD-SCDMA) network or a global system mobile (GSM) network; and
wherein said second radio access network comprises a global system mobile (GSM) network when the first radio access network comprises a TD-SCDMA network and comprises a TD-SCDMA network when the first radio access network comprises a GSM network.

40. The UE of claim 37 in which the first call type and second call type are one of:
the first call type is a packet-switched call and the second call type is a circuit-switched call; and
the second call type is a packet-switched call and the first call type is a circuit-switched call.
